(19) United States
(12) Patent Application Publication
(10) Pub. No.: US 2008/0203937 A1
(43) Pub. Date: Aug. 28, 2008

(54) Method and a Circuit Arrangement for Operating a High Intensity Discharge Lamp

(75) Inventors: Christofher Daniel Charles Hooijer, Eindhoven (NL); Thijs Oosterbaan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/815,874

(22) PCT Filed: Feb. 7, 2006
(86) PCT No.: PCT/IB06/50388

§ 371 Date: Aug. 9, 2007

(30) Foreign Application Priority Data
Feb. 14, 2005 (EP) 05101049.4

(51) Int. Cl. H05B 41/28

(52) U.S. Cl. 315/276

(57) ABSTRACT

A method and a circuit arrangement (1) for operating a high intensity discharge lamp (2), which is supplied by direct current (DC) supply lines (4, 6), comprising a transformer (40), of which a primary winding (42) is connected in series with an inductor (46) and a capacitor (48) to the DC supply lines (4, 6), a secondary winding (44) of the transformer is connected in series with the lamp, a switch (52) is connected in parallel to the capacitor (48), and a control circuit (56) is connected to the switch (52), whereby the control circuit (56) controls the switch to conduct upon detecting a zero crossing of a voltage (Vsw) at the switch, and the control circuit controls the switch to not conduct upon detecting a value of a current through the switch which is greater than a reference value.

### FIELD OF THE INVENTION

The invention relates to a method and a circuit arrangement for operating a high intensity discharge (HID) lamp as described in the preambles of claim 1 and 7, respectively.

### BACKGROUND OF THE INVENTION

WO 2004/064457 discloses a circuit arrangement for operating a high pressure discharge lamp, which is one type of a high intensity discharge (HID) lamp. The circuit disclosed by said document is similar to the circuit referred to above.

From the time a HID lamp is supplied its operation goes through several phases, that is, a breakdown phase, a takeover phase, a cold-to-hot cathode transition phase, a run-up phase and a steady-state phase. Details about these phases are disclosed by L. C. Pitchford et al, in Journal of Applied Physics, volume 82, 1 Jul. 1997.

A capacitor of the prior art resonant ignition part is connected across the lamp. The transformer of the resonant ignition part is connected in series with the lamp. The transformer can be an autotransformer. Upon switching on the supply to the arrangement the control circuit switches the switch of the ignition part on and off alternately, thus generating an alternating current through said capacitor and the primary winding of the transformer of the resonant ignition part. By decreasing the switching frequency the ignition voltage is decreased. The switching frequency must be such that the ignition voltage frequency is a multiple of the switching frequency. At start up a high voltage will be generated across said capacitor and thus across the lamp, which is connected in parallel to it. At some instant the lamp will breakdown. The voltage across the lamp will then have shown a pulse shape with a high level. After break down the ignition part is maintained operating so that an alternating current of a frequency determined by said resonant ignition part is generated and fed through said capacitor and the lamp. Upon detecting a relatively low magnitude of a voltage across the lamp, the lamp is considered to be in the run-up phase of operation, and the resonant ignition part is switched off. A relatively low frequency current, not provided by the resonant ignition circuit, then passes through the lamp only. A power supply circuit (APS) is connected in parallel to one capacitor of a series of two buffer capacitors, which are connected to the DC supply lines, The APS is used to maintain a half bridge voltage constant during ignition.

An ignition rate, or a time it takes for the lamp to ignite, is dependent on the product of an amplitude of an ignition voltage and its frequency. The prior art circuit does not allow a high ignition frequency. Therefore it must generate a high ignition voltage to attain a value of said product which is required to obtain and sustain ignition. Such relatively low ignition frequency and high ignition voltage require a bulky ignition transformer, which is a drawback.

Another disadvantage of the prior art circuit arrangement is, that it requires the use of an additional supply circuit, which makes the circuit as a whole more complex and expensive.

### OBJECT OF THE INVENTION

It is an object of the invention to solve the drawbacks of the prior art method and circuit as described above.

### SUMMARY OF THE INVENTION

The above object of the invention is achieved by providing a method as described in claim 1.

The controlling of the generating of a primary current at zero crossings of a voltage of the resonance circuit reduces switching losses by said generation. Therefore, a high switching frequency and a high resonance frequency of the igniter part can be used. As a consequence, when using a relatively high resonance frequency a lower ignition voltage is needed to attain and sustain ignition. Therefore, the transformer may be small and more cost effective. On the other hand, a high primary voltage of the transformer allows to use a reduced winding ratio, a lower secondary inductance and also smaller sizes and reduced costs.

The above mentioned object is achieved also by providing a circuit arrangement as described in claim 7.

Preferably a transformer of a saturation type is used of which the primary winding is connected in series with an additional inductor and the capacitor of the ignition resonance part. As a result, when the transformer saturates, an increase rate of a current in the primary winding of the transformer is limited. Therefore, short circuiting of the secondary winding of the transformer or of the lamp will have no significant effect on the current and voltage of the primary winding. Said current and voltage are determined basically by the additional inductor and the capacitor of the ignition resonance part. Therefore such a circuit arrangement is very robust.

### BRIEF DESCRIPTION OF THE DRAWINGS

The invention will become more gradually apparent from the following exemplary description in connection with the accompanying drawing. In the drawing:

FIG. 1 shows a diagram of an embodiment of a circuit arrangement for operating a high intensity discharge lamp according to the invention; and

FIG. 2 shows a time diagram of voltages and a current occurring during operation of the circuit arrangement shown in FIG. 1.

### DETAILED DESCRIPTION OF AN EXAMPLE

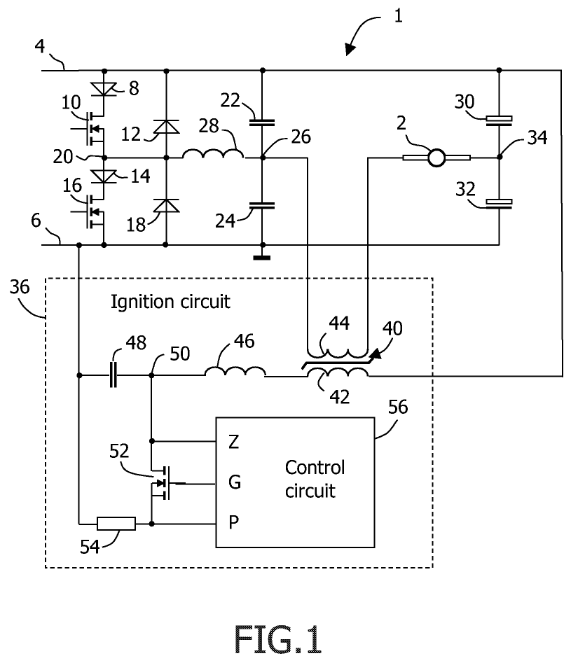

FIG. 1 shows a diagram of a circuit arrangement 1 for operating a high intensity discharge (HID) lamp 2. The circuit arrangement comprises two direct current DC supply lines 4 and 6. Assuming that a voltage on line 6 is zero, a DC supply voltage on line 4 is positive.

The circuit arrangement 1 further comprises a down converter. The arrangement of the converter is not part of the invention. Therefore only a part of it is shown, in particular two switch circuits, which are connected in series to the supply lines 4 and 6. One of said switch circuits comprises a series circuit of a forward biased diode 8 and a MOSFET switch 10 and in parallel to said series circuit a reversed biased diode 12. The other switch circuit comprises a series circuit of a forward biased diode 14 and a MOSFET switch 16 and in parallel to said series circuit a reversed biased diode 18. The switch circuits have a common connection point or node 20.

A series circuit of two small filter capacitors 22 and 24, for example in the order of a few hundreds nanoFarad, having a common node 26 is connected also to the supply lines 4 and 6. An inductor 28 is connected to node 20 and node 26. Capacitors 22 and 24 are used for filtering high frequency alterations of a current through inductor 28. A series circuit of two relatively large buffer capacitors, 30 and 32, for example of 47 μF, having a common node 34 is connected also to the supply lines 4 and 6. Buffer capacitors 30 and 32 are used to keep the voltage (half bridge voltage) at node 34 substantially constant. A series circuit of the lamp 2 and an ignition circuit 36 is connected to nodes 26 and 34.

During normal operation a control circuit (not shown) of the down converter generates sequences of pulses by which it turns on one switch 10 or 16 while turning off the other switch 16 and 10, respectively. Said pulses are generated at a high frequency, e.g. 20-500 kHz. The sequences are chosen such, possibly dynamically, that the lamp 2 is supplied with a DC current, which changes direction at a lower frequency than said high frequency of the switch control pulse sequences. Such commutation at a relatively low frequency is necessary to maintain proper operation of the lamp. This operation scheme and its implementation are not part of the invention.

From the time a HID lamp is supplied its operation goes through several phases, that is, a breakdown phase, a takeover phase, a cold-to-hot cathode transition phase, a run-up phase and a steady-state phase. Just before breakdown of the lamp 2 a high voltage will occur across the lamp 2. Upon breakdown of the lamp 2 (lamp becomes conductive) its impedance is reduced very significant. As a result the voltage across the lamp 2 is reduced. Said voltage is to low to sustain a conductive state of the lamp 2 by itself. To prevent that the lamp 2 extinguishes upon breakdown of the lamp an ignition circuit is used. FIG. 1 shows an embodiment of such an ignition circuit 36 according to the invention.

The ignition circuit 36 comprises a transformer 40, which has a primary winding 42 and a secondary winding 44. It is said secondary winding 44 by which the ignition circuit 36 is connected in series with the lamp 2. The primary winding 42 is connected in series with an inductor 46 and a capacitor 48 to the supply lines 4 and 6, with the capacitor 48 connected to supply line 6. A terminal of capacitor 48 or a connection node 50 is connected to a series circuit of a MOSFET switch 52 and a resistor 54, with the resistor connected to supply line 6. The drain, gate and source of MOSFET 52 are connected to a Z-input, a G-output and a P-input of a control circuit 56, respectively. The control circuit may be a commercially available integrated circuit, such as the one indicated by L6562 of ST-Microelectronics. The control circuit measures the voltage V_{sw} at its Z-input and it detects a zero crossing of said voltage. Resistor 54 has a small value and it is used to measure a current flowing through it and therefore a current Iₚᵣᵢₘ through the primary winding 42 of transformer 40, the inductor 46 and MOSFET 52. The control circuit measures the voltage at its P-input and it compares it with a reference value. Said reference value represents a value of the current Iₚᵣᵢₘ at which the control circuit must alter a gate voltage V_{g} at its G-output by which it controls MOSFET switch 52. Said reference value will be referred to also as current reference value I_{ref}.

The ignition circuit 36 operates as follows.

Upon application of a supply voltage to supply lines 4 and 6 control circuit 56 will control switch 52 to conduct. A current Iₚᵣᵢₘ will flow through the primary winding 42 of transformer 40, inductor 46, capacitor 48 and switch 52. This current Iₚᵣᵢₘ will increase. When the measured current reaches the current reference value I_{ref} the control circuit 56 controls switch 52 to not conduct. Energy built up then in the series circuit of the primary winding 42, inductor 46 and capacitor 48 will make this series circuit to resonate. Therefore this series circuit is referred to also as resonance circuit.

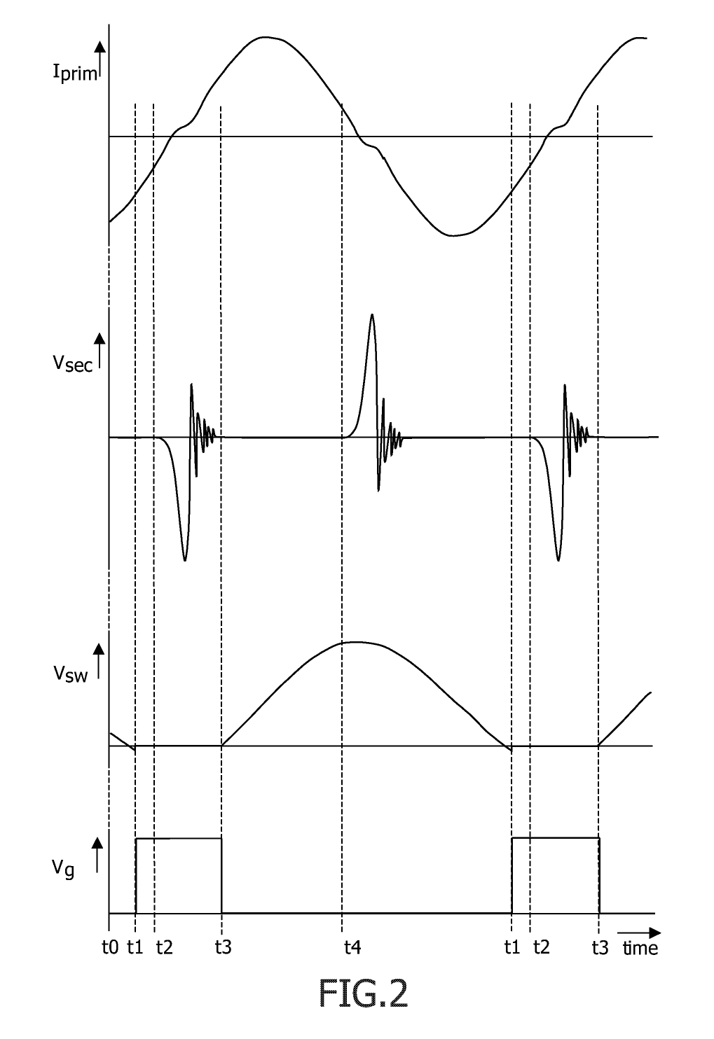

The current Iₚᵣᵢₘ which flows through the resonance circuit is shown in FIG. 2. With the transformer 40 being of a saturation type it will not transfer energy to the secondary winding 44 for a part of the cycle time of the primary winding current Iₚᵣᵢₘ. FIG. 2 shows that from time t2 the transformer returns from being saturated and energy transfer may occur. As a result the primary winding current Iₚᵣᵢₘ will induce a voltage pulse across the secondary winding 44, as is shown by voltage V_{sec} in FIG. 2.

Upon detecting a zero-crossing of the voltage V_{sw}, at time t1 in FIG. 2, at its Z-input the control circuit 56 controls switch 52 to conduct. Upon reaching the current reference value, at time t3 in FIG. 2, the control circuit will control switch 52 to not conduct. Between times t 1 and t3 energy will be fed from the supply lines into the resonance circuit, such that resonance is sustained.

As an example, with inductor 46 having a value of 250 μH, capacitor 48 having a value of 8.2 nF, and Iₚᵣᵢₘ having a peak value of 3 A, a peak value of the voltage V_{sec} at the secondary winding 44 was obtained. A sequence of such voltage pulses of V_{sec} could keep a 200 W lamp 2 in a takeover phase for the time it took to reach the succeeding cold-to-hot cathode transition phase. The primary winding current Iₚᵣᵢₘ had a cycle time of only 14 μs, by which high secondary voltage pulses could be generated and the size of the transformer could be made small. The voltage V_{sw} at switch 52 had a high peak value of 850 V. Therefore, a voltage across the primary winding had a high peak value too. As a consequence, the turn ratio of the windings 42 and 44 of transformer 40 could be small, so that value of the inductance of the secondary winding could be small and therefore the transformer 40 and the ignition circuit 36 as a whole could be small.

Since the transformer 40 is of a saturation type short circuiting of its secondary winding 44 or of the lamp 2 will have no significant effect on the voltage V_{sw} and the current Iₚᵣᵢₘ at the primary side of the transformer 40. This makes the ignition circuit, and thereby the circuit arrangement as a whole, robust.

The operation of the ignition circuit 36 can be stopped upon reaching the cold-to-hot cathode transition phase or, short after that, the normal operation phase of the lamp 2. To do this, a change of impedance of the lamp 2 could be detected. Since the lamp 2 is a load for the ignition circuit 36, its primary winding current Iₚᵣᵢₘ will change by a change of lamp impedance. Consequently, the time that the control circuit 56 controls the switch 52 to conduct (or not) will change also. Therefore by comparing the conducting time of switch 52 to a reference value the control circuit 52 may decide to control the switch 52 to not conduct anymore.

Instead of, or in addition to, detecting an operation state of the lamp 2, based on change of its impedance, a timer could be used to stop operation of the ignition circuit 36 after a specific time from the application of the supply voltage.

A preferred embodiment of circuit arrangement for operating a high intensity discharge lamp has been described herein before. It must be observed that the invention is determined by the annexed claims and that modifications to said preferred embodiment can be made within the scope of the invention.

1. A method of operating a high pressure discharge lamp (2), comprising:
applying a direct current (DC) supply voltage to DC supply lines (4,6);
generating an alternating current (AC) voltage from the supply voltage;
applying the AC voltage to the lamp, such that the lamp may breakdown;
generating an AC primary current (Iₚᵣᵢₘ) in a primary winding (42) of a transformer (40), with the primary winding (42) being part of a resonance circuit, such that an AC ignition voltage (V_{sec}) is generated at a secondary winding (44) of the transformer (40), with the secondary winding (44) being connected in series with the lamp (2);
whereby the AC ignition voltage (V_{sec}) has a frequency and an amplitude which are suitable to sustain the breakdown of the lamp during a takeover phase of the lamp succeeding the breakdown, and resonance of the resonance circuit is sustained by repetitively temporarily connecting a connection point (50) of the resonance circuit to one (6) of said supply lines (4,6), characterized by, before the applying of the DC supply voltage, connecting the resonance circuit to both supply lines (4, 6), connecting the lamp (2) to the resonance circuit by said transformer (40) only, and during the takeover phase, monitoring a voltage (V_{sw}) at said connection point (50) of the resonance circuit, monitoring the primary current (Iₚᵣᵢₘ), connecting said connection point (50) of the resonance circuit to said one supply line (6) upon (t1) detecting a zero-crossing of the monitored voltage and to break a connection between said connection point (50) and said one supply line when (t3) an amplitude of the primary current (Iₚᵣᵢₘ) becomes greater than a reference value.

2. Method according to claim 1, characterized in that the transformer (40) and the primary current (Iₚᵣᵢₘ) are such that the transformer saturates during a part of a cycle time of the primary current where the amplitude of the primary current is beyond a saturation level, and that an inductor is connected in series with the primary winding (42) of the transformer.

3. Method according to claim 1, characterized in that the generating of the primary current (Iₚᵣᵢₘ) is stopped after completion of the takeover phase of the lamp (2).

4. Method according to claim 3, characterized in that during said monitoring, an operating state of the lamp (2) is derived from the monitored voltage (V_{sw}) and the monitored primary current (Iₚᵣᵢₘ) and that the generating of the primary current (Iₚᵣᵢₘ) is stopped after detection of completion of the takeover phase as the operation state of the lamp (2).

5. Method according to claim 4, characterized in that the operation state of the lamp (2) is derived from the duration of a period during which said connection point (50) of the resonance circuit is connected to said one supply line (6).

6. Method according to claim 3, characterized in that the generating of the primary current (Iₚᵣᵢₘ) is stopped after timeout of a predetermined period of time from the applying of the DC supply voltage.

7. A circuit arrangement (1) for operating a high intensity discharge lamp (2), which is supplied by direct current (DC) supply lines (4, 6), comprising a resonant ignition part of a transformer (40) and a capacitor (48), a primary winding (42) of the transformer is connected in series with a switch (52) to the supply lines (4, 6), a secondary winding (44) of the transformer is connected in series with the lamp, and a control circuit (56), which is connected to the switch (52) to control the switch to conduct and to not conduct at a rate which sustains resonance of the resonant ignition part for at least a takeover phase of the lamp, characterized in that the primary winding (42) of the transformer (40) and the capacitor (48) are connected in series to the DC supply lines (4, 6), the switch (52) is connected in parallel to the capacitor (48), whereby the control circuit (56) controls the switch to conduct upon detecting a zero crossing of a voltage (V_{sw}) at the switch, and the control circuit controls the switch to not conduct upon detecting a value of a current through the switch which is greater than a reference value.

8. Circuit arrangement according to claim 7, characterized in that the transformer (40) is a saturation transformer and an inductor (46) is connected in series with the primary winding (42) of the transformer (40) and the capacitor (48).

9. Circuit arrangement according to claim 7, characterized in that the control circuit (56) controls and maintains the switch (52) to not conduct after the takeover phase of the lamp (2).

10. Circuit arrangement according to claim 9, characterized in that the control circuit (56) monitors an operation state of the lamp (2), and the control circuit (56) terminates the control of the switch (52) to conduct after detecting completion of the take-over phase as operation state of the lamp.

11. Circuit arrangement according to claim 10, characterized in that the control circuit (56) measures a time that the switch (52) is conducting, and the control circuit terminates the control of the switch (52) to conduct when the measured time has passed a reference value.

12. Circuit arrangement according to claim 9, characterized in that the control circuit (56) controls and maintains the switch (52) to not conduct after time-out of a period of time from a first controlling of the switch.
